(19) United States
(12) Patent Application Publication
(10) Pub. No.: US 2010/0014703 A1
(43) Pub. Date: Jan. 21, 2010

(54) Loudspeaker

(75) Inventors: Hung-Chi Wang, Taipei Hsien (TW); Kun-Li Huang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/176,111

(22) Filed: Jul. 18, 2008

(51) Int. Cl. H04R 1/00

(52) U.S. Cl. 381/398

(57) ABSTRACT

A loudspeaker according to the present invention includes a frame body, a leading wire board disposed underneath the frame body, a magnet mounted in the frame body, a pad ring glued on an edge of the frame body, a diaphragm whose exterior rim is glued on the pad ring and a voice coil assembled in the frame body and surrounding the magnet. A top of the voice coil is adhered to a bottom of the diaphragm and two free ends of the voice coil are soldered to the leading wire board. The pad ring is made of plastic material.

### BACKGROUND OF THE INVENTION

1. Field of the Invention

The present invention relates to a loudspeaker, and more particularly to a loudspeaker having high stability.

2. The Related Art

Referring to FIGS. 1 and 2, a conventional loudspeaker is shown. The loudspeaker has a pad ring 6′ disposed between a frame body 2′ and a diaphragm 8′. The pad ring 6′ is made of metal material and has a gluing surface 61′ and an inner surface 62′. An edge of the diaphragm 8′ is glued on the gluing surface 61′. However, as the pad ring 6′ is made of the metal material, during process of forming the pad ring 6′ by punching off part material of a circular metal sheet using punches, an arc-shaped surface 63′ is apt to be formed at the junction of the gluing surface 61′ and the inner surface 62′ to result in a decrease of a contacting area between the diaphragm 8′ and the pad ring 6′. As a result, when the loudspeaker works for a long time, the diaphragm 8′ is apt to become unsteady so that stability of the loudspeaker is reduced. Furthermore, the metal pad ring 6′ needs an antirust process that results in an increase of the cost and the working-hour.

### SUMMARY OF THE INVENTION

An object of the present invention is to provide a loudspeaker. The loudspeaker includes a frame body, a leading wire board disposed underneath the frame body, a magnet mounted in the frame body, a pad ring glued on an edge of the frame body, a diaphragm whose exterior rim is glued on the pad ring and a voice coil assembled in the frame body and surrounding the magnet. A top of the voice coil is adhered to a bottom of the diaphragm and two free ends of the voice coil are soldered to the leading wire board. The pad ring is made of plastic material.

As described above, since the pad ring is made of the plastic material, when the pad ring is injection molded in a mold, an arc-shaped surface can be avoided to form on the pad ring. Meanwhile, the pad ring made of the plastic material makes it unnecessary to use an antirust process in production of the pad ring, thus reducing significantly the cost and the working-hour.

### BRIEF DESCRIPTION OF THE DRAWINGS

The present invention will be apparent to those skilled in the art by reading the following description of a preferred embodiment thereof, with reference to the attached drawings, in which:

FIG. 1 is a cross-sectional view of a conventional loudspeaker;

FIG. 2 is an enlarged view of an encircled portion II of FIG. 1;

FIG. 3 is an exploded view of a loudspeaker according to the present invention;

FIG. 4 is a perspective view of a frame body of the loudspeaker of FIG. 3;

FIG. 5 is a cross-sectional view of the loudspeaker of FIG. 3; and

FIG. 6 is an enlarged view of an encircled portion VI of FIG. 5.

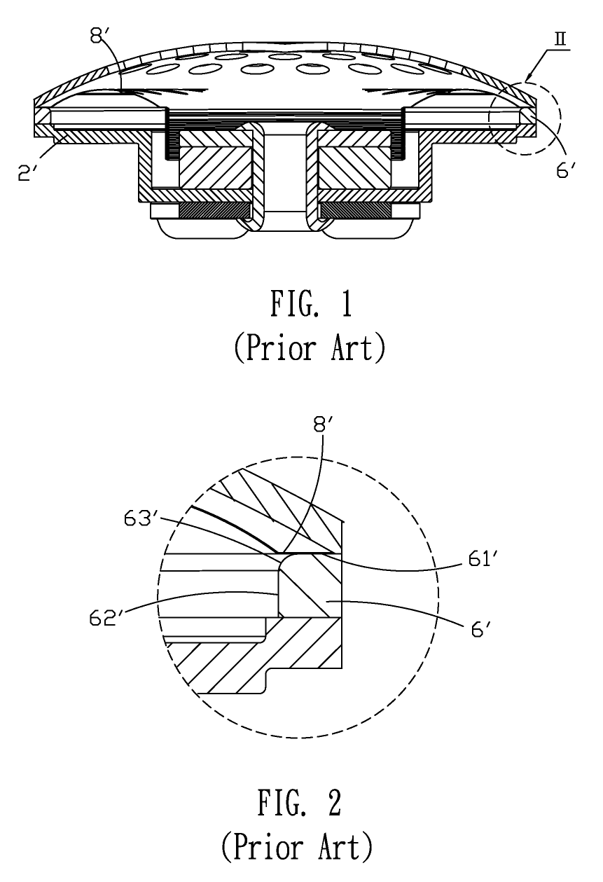

### DETAILED DESCRIPTION OF THE PREFERRED EMBODIMENT

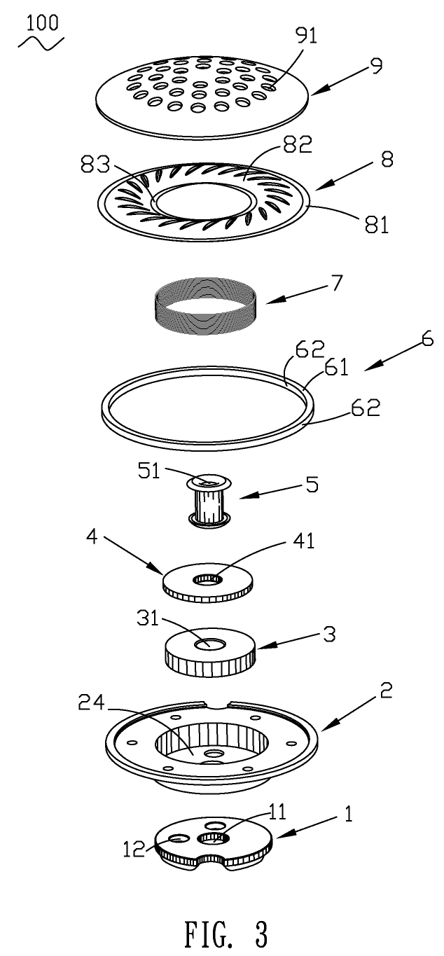

Referring to FIG. 3, a loudspeaker 100 according to the present invention includes a leading wire board 1, a frame body 2, a magnet 3, a permeable washer 4, a rivet 5, a pad ring 6, a voice coil 7, a diaphragm 8 and a shield 9.

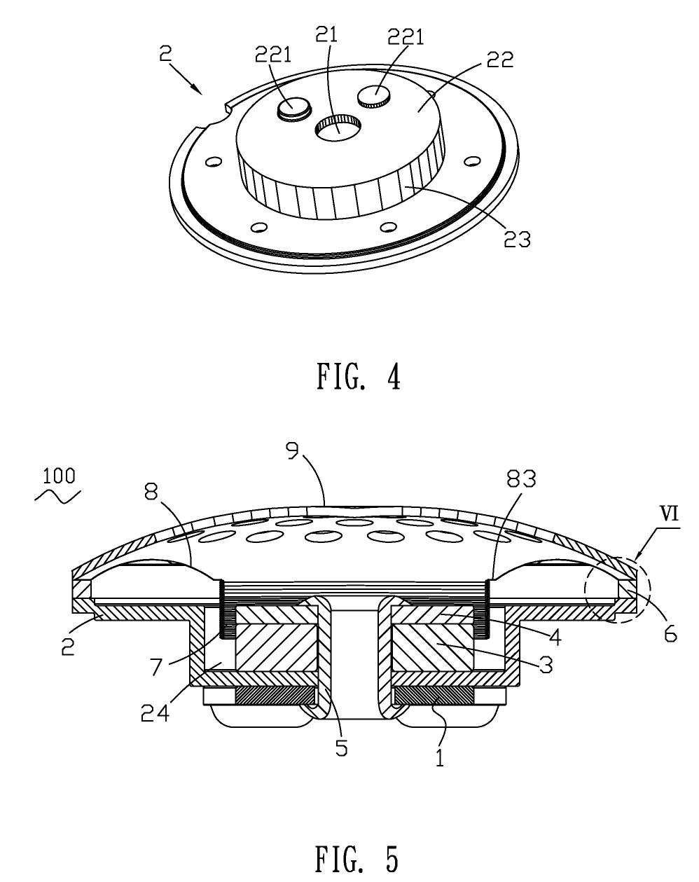

Referring to FIG. 3 and FIG. 4, the frame body 2 is made of permeable materials and is disc-shaped. The center of the frame body 2 is punched downwardly to define a circular bottom board 22 and an annular sidewall 23. Accordingly, a receiving cavity 24 is defined by the bottom board 22 and the sidewall 23. The bottom board 22 defines a center hole 21 in the center thereof and two cylindrical fixing lumps 221 extended downwardly and adjacent to the center hole 21.

Referring to FIG. 3, the leading wire board 1 is a circular printed circuit board and the diameter thereof is approximately equal to the diameter of the bottom board 22 of the frame body 2. The leading wire board 1 defines a fixing hole 11 corresponding to the center hole 21 of the frame body 2 in the center thereof and two fixing apertures 12 beside the fixing hole 11 for engaging with the corresponding fixing lumps 221 of the frame body 2.

The magnet 3 is a cylindrical permanent magnet and the diameter thereof is smaller than the diameter of the bottom board 22. The magnet 3 defines a through hole 31 corresponding to the center hole 21 in the middle thereof. The permeable washer 4 is of a circular shape and the diameter thereof is equal to the diameter of the magnet 3. The permeable washer 4 defines a washer hole 41 corresponding to the through hole 31 in the center thereof. The rivet 5 is column-shaped and the diameter thereof is slightly smaller than the diameter of the holes. The rivet 5 defines a perforation 51 in the middle thereof.

The pad ring 6 is made of plastic material and injection molded in a mold. The pad ring 6 has two gluing surfaces 61 facing to each other and two connecting surfaces 62 respectively connecting the gluing surfaces 61. In the embodiment, the connecting surface 62 and the gluing surface 61 meet with each other at an angle of 90 degrees.

A long wire is coiled to form the voice coil 7 which has a cylindrical shape. The diaphragm 8 has an exterior rim 81 and an interior rim 83 homocentric with each other, and an arched slice 82 connects the exterior rim 81 and the interior rim 83. The shield 9 defines a plurality of openings 91 therethrough for transmitting sound.

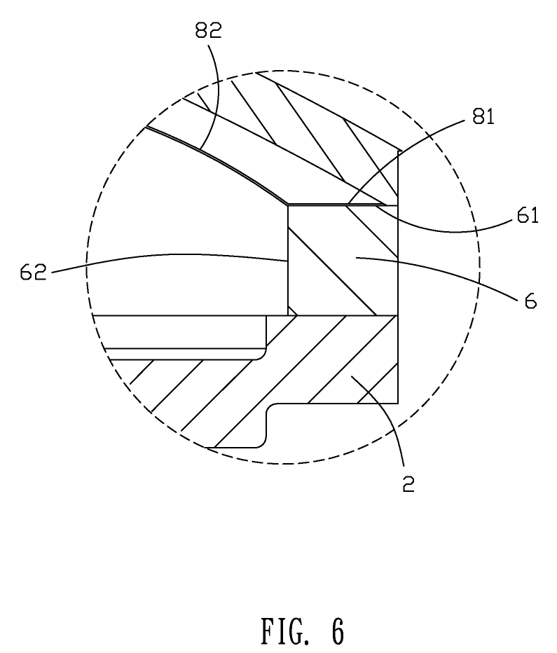

Referring to FIGS. 3-6, during assembly, the fixing lumps 221 of the frame body 2 are inserted in the corresponding fixing apertures 12 of the leading wire board 1 to fix the leading wire board 1 under the bottom board 22. The magnet 3 is mounted in the receiving cavity 24 of the frame body 2. The permeable washer 4 is disposed on the magnet 3 and contained in the receiving cavity 24. The rivet 5 is inserted through the fixing hole 11, the center hole 21, the through hole 31 and the washer hole 41 and finally secures the leading wire board 1, the frame body 2, the magnet 3 and the permeable washer 4 together. One of the gluing surfaces 61 of the pad ring 6 is glued on an edge of the frame body 2. The exterior rim 81 of the diaphragm 8 is glued on the other gluing surface 61. The voice coil 7 is assembled in the receiving cavity 24 and surrounds the permeable washer 4 and the magnet 3. The top of the voice coil 7 is adhered to the interior rim 83 of the diaphragm 8 and two free ends of the voice coil 7 pass through the perforation 51 of the rivet 5 to be soldered to the leading wire board 1. The shield 9 is covered on the diaphragm 8 and an edge of the shield 9 is glued on the exterior rim 81. The openings 91 of the shield 9 conduct the voice from the loudspeaker 100 to the outside.

As described above, the pad ring 6 is made of the plastic material, and therefore when the pad ring 6 is injection molded in the mold, an arc-shaped surface will be avoided to form on the junction of the gluing surface 61 and the connecting surface 62. As a result, the contacting area between the diaphragm 8 and the pad ring 6 is increased to make the diaphragm 8 firmly glued on the pad ring 6 and further improve stability of the loudspeaker 100. Meanwhile, it is also possible to omit an antirust process which otherwise would be necessary in a conventional technology, because the pad ring 6 is made of the plastic material. Thus, the cost and the working-hour are further advantageously reduced.

The foregoing description of the present invention has been presented for purposes of illustration and description. It is not intended to be exhaustive or to limit the invention to the precise form disclosed, and obviously many modifications and variations are possible in light of the above teaching. For example, there are some texture feature design on each of the gluing surfaces 61 in order to enhance the adhesion between the diaphragm 8 and the pad ring 6, the frame body 2 and the pad ring 6. Such modifications and variations that may be apparent to those skilled in the art are intended to be included within the scope of this invention as defined by the accompanying claims.

What is claimed is:

1. A loudspeaker, comprising:
a frame body;
a leading wire board disposed underneath the frame body;
a magnet mounted in the frame body;
a pad ring made of plastic material and glued on an edge of the frame body;
a diaphragm of which an exterior rim is glued on the pad ring; and
a voice coil assembled in the frame body and surrounding the magnet, a top of the voice coil being adhered to a bottom of the diaphragm, two free ends of the voice coil being soldered to the leading wire board.

2. The loudspeaker as claimed in claim 1, wherein a radial cross-section of the pad ring is a rectangle.

3. The loudspeaker as claimed in claim 1, wherein the pad ring has two gluing surfaces respectively glued to the exterior rim of the diaphragm and the edge of the frame body, each of the gluing surfaces is processed with some texture feature design.

4. The loudspeaker as claimed in claim 1, further comprising a rivet defining a perforation therethrough, the rivet combines the leading wire board, the frame body and the magnet together, the two free ends of the voice coil pass through the perforation of the rivet to be soldered to the leading wire board.
